(19) United States
(12) Patent Application Publication
(10) Pub. No.: US 2009/0129412 A1
(43) Pub. Date: May 21, 2009

(54) Apparatus for bonding camera module, equipment for assembling camera module having the apparatus, and method of assembling camera module using the equipment

(75) Inventor: Sung-Wook Kim, Seoul (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-si (KR)

(21) Appl. No.: 12/288,392

(22) Filed: Oct. 20, 2008

(30) Foreign Application Priority Data
Nov. 20, 2007 (KR) 10-2007-0118673

(51) Int. Cl. H01S 3/30; B23P 19/00

(52) U.S. Cl. 372/6; 29/739

(57) ABSTRACT

An apparatus for bonding a camera module, equipment for assembling the camera module having the apparatus, and a method of assembling the camera module using the equipment. The apparatus include: a laser generator, which generates a laser beam, and a bonding head, which is connected to the laser generator through an optical fiber and applies the laser beam propagating through the optical fiber to contact portions of a camera unit having an image sensor and lenses and a flexible printed circuit board (FPCB) electrically connected to the image sensor, so that the contact portions can be heated and bonded to each other such that the camera unit and the FPCB are bonded to each other. Thus, a process of bonding the camera module can be performed within a relatively short time, compared to the case where a hot-bar or an oven is used.

### CROSS-REFERENCE TO RELATED APPLICATION

This application claims the benefit of Korean Patent Application No. 2007-118673, filed Nov. 20, 2007, the entire content of which is hereby incorporated herein by reference.

### BACKGROUND OF THE INVENTION

1. Field of the Invention

The present invention relates to an apparatus for bonding a camera module, equipment for assembling the camera module having the apparatus, and a method of assembling the camera module using the equipment. More particularly, the present invention relates to an apparatus for bonding a camera module using a laser beam, equipment for assembling the camera module having the apparatus, and a method of assembling the camera module using the equipment.

2. Description of the Related Art

The integration and combination of digital technologies has led to the rapid spread of telecommunication terminals capable of realizing voice and image communication at the same time. This, in turn, has resulted in an abrupt increase in demand for small camera modules for image communication using the telecommunication terminals.

A recent trend is to make electronic devices lightweight, thin, and compact. This trend is particularly prevalent when it comes to camera modules and telecommunication terminals capable of simultaneous voice and image communication.

For example, recent camera modules used a flexible printed circuit board (FPCB) for connection of an image sensor and a main board so that the module can be lightweight, have a thin profile, and be compact. The FPCB is thin, lightweight, has high heat resistance and high flexure resistance, and thus can contribute to the high performance, lightweight, thin profile, and compact size of camera modules.

Camera modules generally include a camera unit having an image sensor 1o and lenses, and an FPCB connecting the image sensor to a main board. Accordingly, when the camera unit having the image sensor and lenses is prepared, camera module assembly equipment having an apparatus for bonding a camera module mounts and bonds the prepared camera unit to the FPCB, thereby completing assembly of the camera module.

Two methods have conventionally been used for bonding the camera unit and the FPCB.

One of the two methods is a thermo-compression bonding method using a hot bar. In this thermo-compression bonding method, a camera unit having an image sensor and lenses is fixed to a jig, an FPCB is mounted above the image sensor of the camera unit, and the FPCB is pressurized downward from its topside while being heated using the hot bar at a high temperature. Thereby, the camera unit is bonded to the FPCB. The method, however, has the drawback that it takes a long time to heat and pressurize the FPCB because the heat of the hot bar and the pressure must be transmitted to a bonding zone of the camera unit and the FPCB. Therefore, when the camera unit is bonded with the FPCB, the method may cause deformation in a lens barrel or a lens housing for fixing the lenses, which corresponds to a part of the camera unit, during the thermo-compression bonding process. This deformation leads to a change in focal point of each lens which was previously adjusted when fixed to the lens barrel or the lens housing.

The other method is a reflow-soldering method using a circulation heater. According to the reflow-soldering method, a camera unit having an image sensor and lenses is mounted on an FPCB, the FPCB is disposed in a reflow oven, and the FPCB and the camera unit are heated at a high temperature using a circulation heater such that the camera unit is bonded to the FPCB under its own weight.

The method, however, causes deformation or melting in a part of the camera module which is vulnerable to heat due to long heating time. Especially, since a bonding pad for bonding these components has recently been made of a Pb-free material having a relatively high bonding temperature, the long heating time tends to result in deformation or melting quite frequently.

Moreover, since the known reflow-soldering method is carried out in a reflow oven having a relatively narrow heating space, it causes another problem of vapor or particles generated from the bonding pad in the reflow oven attaching to the image sensor or lenses of the camera module. This distorts the optical image of an object captured by the camera module.

### SUMMARY OF THE INVENTION

Embodiments of the present invention provide an apparatus for bonding a camera module capable of heating and bonding a camera unit and a flexible printed circuit board (FPCB) within a relatively short time, equipment for assembling the camera module having the apparatus, and a method of assembling the camera module using the equipment. Other embodiments of the present invention provide an apparatus for bonding a camera module capable of bonding a camera unit and an FPCB by selectively heating only pads for bonding the camera unit and the FPCB, equipment for assembling the camera module having the apparatus, and a method of assembling the camera module using the equipment.

One embodiment of the present invention is directed to an apparatus for bonding a camera module. The apparatus includes a laser generator, which generates a laser beam, and a bonding head, which is connected to the laser generator through an optical fiber and applies the laser beam propagating through the optical fiber to contact portions of a camera unit having an image sensor and lenses and a flexible printed circuit board (FPCB) electrically connected to the image sensor, such that the camera unit and the FPCB are bonded to each other.

The bonding head may be disposed on an optical path between the laser generator and the contact portions, and may include at least one scan mirror, which refracts the laser beam emitted from the laser generator such that a position of the applied laser beam is changed. In this case, the bonding head may further include a focusing lens, which is disposed on an optical path between the laser generator and the scan mirror in order to adjust at least one of width and length of the laser beam propagating through the optical fiber, and a linear velocity-equalizing lens, which is disposed on an optical path between the scan mirror and the contact portions and refracts the laser beam such that the laser beam applied to the contact portions is applied to surfaces of the contact portions with constant or substantially constant linear velocity. The camera module bonding apparatus may also include a pressing tool disposed between the contact portions and the bonding head to press the contact portions and made of a transparent material such that the laser beam applied from the bonding head is transmitted. The camera unit may further include a hard printed circuit board (HPCB) having a plurality of first bonding pads such that the image sensor is bonded to one surface thereof and the FPCB is bonded to the other surface thereof. The FPCB may include a plurality of second bonding pads on one surface thereof to be bonded to the first bonding pads, and the bonding head may apply the laser beam to contact portions of the bonding pads from a side of the other surface of the FPCB when the first bonding pads and the second bonding pads come into contact with each other.

The first bonding pads and the second bonding pads may be formed at edges of the HPCB and the FPCB, respectively. In this case, the bonding head may apply the laser beam to the edges at which the bonding pads are formed. The bonding head may apply the laser beam having a predetermined width to the contact portions of the bonding pads, and the width of the applied laser beam may be equal or similar to that of either each second bonding pad or the FPCB. The bonding head may apply the laser beam having a predetermined area to the contact portions of the bonding pads, and the area of the applied laser beam may be equal or similar to that of the other surface of the HPCB.

Another embodiment of the present invention is directed to equipment for assembling a camera module. The camera module assembly equipment includes a component-mounting device, which mounts a flexible printed circuit board (FPCB) electrically connected to an image sensor above a camera unit having the image sensor and lenses, or which mounts the camera unit above the FPCB, and a camera module bonding apparatus, which bonds the camera unit and the FPCB mounted by the component-mounting device using a laser beam. The camera module bonding apparatus comprises a laser generator, which generates a laser beam, and a bonding head, which is connected to the laser generator through an optical fiber and applies the laser beam propagating through the optical fiber to contact portions of the camera unit and the FPCB such that the camera unit and the FPCB are bonded to each other.

A further embodiment of the present invention is directed to a method of assembling a camera module. The method includes mounting a flexible printed circuit board (FPCB) electrically connected to an image sensor above a camera unit having the image sensor and lenses using a component-mounting device, or mounting the camera unit above the FPCB using the component-mounting device, and applying a laser beam to contact portions of the camera unit and the FPCB such that the camera unit and the FPCB are bonded to each other using a camera module bonding apparatus including a laser generator and a bonding head to which the laser beam is guided from the laser generator.

The method may further include refracting the laser beam guided from the laser generator using at least one scan mirror installed on the bonding head such that a position of the applied laser beam is changed. The bonding may include adjusting at least one of width and length of the laser beam propagating to the bonding head through an optical fiber using a focusing lens installed on the bonding head. The method may further include pressing the contact portions using a pressing tool, which is disposed between the contact portions and the bonding head to press the contact portions and is made of a transparent material such that the laser beam applied from the bonding head is transmitted.

In addition, the camera unit may further include a hard printed circuit board (HPCB) having a plurality of first bonding pads such that the image sensor is bonded to one surface thereof and the FPCB is bonded to the other surface thereof, and the FPCB may include a plurality of second bonding pads on one surface thereof to be bonded to the first bonding pads. In this case, the bonding may include applying the laser beam to contact portions of the bonding pads from a side of the other surface of the FPCB when the first bonding pads and the second bonding pads come into contact with each other.

The first bonding pads and the second bonding pads may be formed at edges of the HPCB and the FPCB, respectively. In this case, the bonding may include applying the laser beam to the edges at which the bonding pads are formed using the bonding head. The bonding may include applying the laser beam having a predetermined width to the contact portions of the bonding pads using the bonding head, and the width of the applied laser beam may be equal or similar to that of either each second bonding pad or the FPCB. Also, the bonding may include applying the laser beam having a predetermined area to the contact portions of the bonding pads using the bonding head, and the area of the applied laser beam may be equal or similar to that of the other surface of the HPCB.

### BRIEF DESCRIPTION OF THE DRAWINGS

The above and other objects, features and advantages of the present invention will become more apparent by describing certain exemplary embodiments thereof with reference to the attached drawings, in which:

FIG. 1 is a cross-sectional view illustrating an example of a camera module assembled by equipment for assembling a camera module according to an exemplary embodiment of the present invention;

FIG. 2 is an exploded cross-sectional view illustrating an example of a camera unit of the camera module of FIG. 1;

FIG. 3 illustrates both the image sensor of FIG. 2 and the bottom surface of a circuit board to which the image sensor is bonded;

FIG. 4 is a block diagram illustrating an example of the configuration of equipment for assembling a camera module according to an exemplary embodiment of the present invention;

FIG. 5 is a plan view illustrating an example of an exemplary embodiment of the camera module bonding apparatus illustrated in FIG. 4;

FIG. 6 is a bottom view illustrating an example of a method of bonding a camera module using the camera module bonding apparatus of FIG. 5;

FIGS. 7A through 7C are diagrams illustrating an example of a method of assembling a camera module using both the camera module bonding apparatus illustrated in FIG. 5 and a component-mounting device;

FIG. 8 is a perspective view illustrating an example of another exemplary embodiment of a camera module bonding apparatus according to the present invention:

FIG. 9 is a bottom view illustrating an example of a method of bonding a camera module using the camera module bonding apparatus illustrated in FIG. 8;

FIG. 10 is a side view illustrating an example of a method of bonding a camera module using the camera module bonding apparatus illustrated in FIG. 8;

FIG. 11 is a perspective view illustrating an example of a further exemplary embodiment of a camera module bonding apparatus according to the present invention:

FIG. 12 is a bottom view illustrating an example of a method of bonding a camera module using the camera module bonding apparatus illustrated in FIG. 11;

FIG. 13 is a side view illustrating an example of a method of bonding a camera module using the camera module bonding apparatus illustrated in FIG. 11;

FIGS. 14A through 14C are diagrams illustrating an example of a method of assembling a camera module using both the camera module bonding apparatus illustrated in FIG. 11 and a component-mounting device; and

FIG. 15 is a perspective view illustrating still another exemplary embodiment of a camera module bonding apparatus according to the present invention.

### DETAILED DESCRIPTION OF THE EMBODIMENTS

The present invention will now be described more fully hereinafter with reference to the accompanying drawings, in which exemplary embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Throughout the drawings, it is noted that the same reference numerals or letters will be used to designate like or equivalent elements having the same function

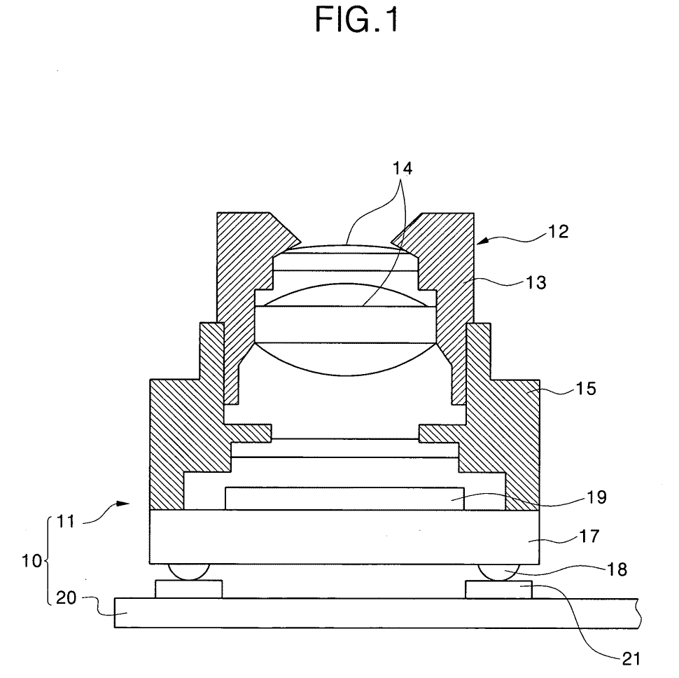

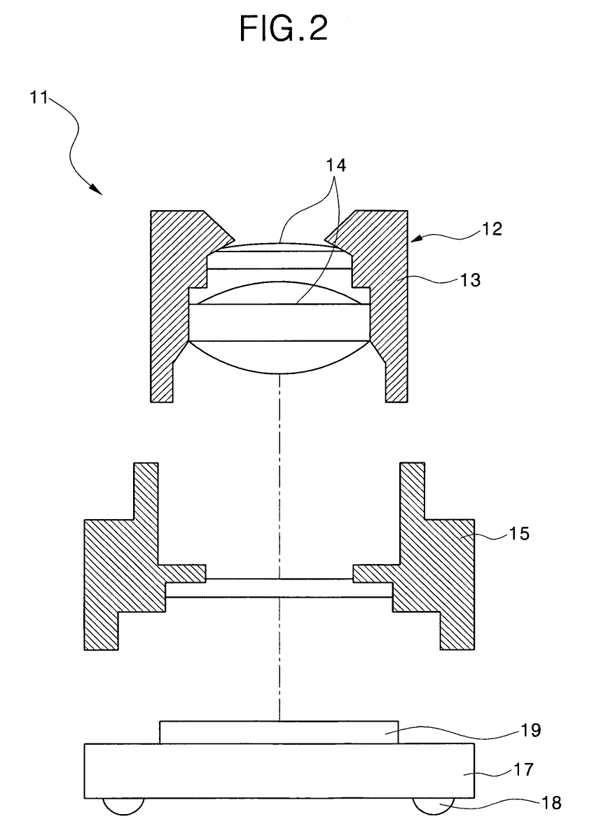

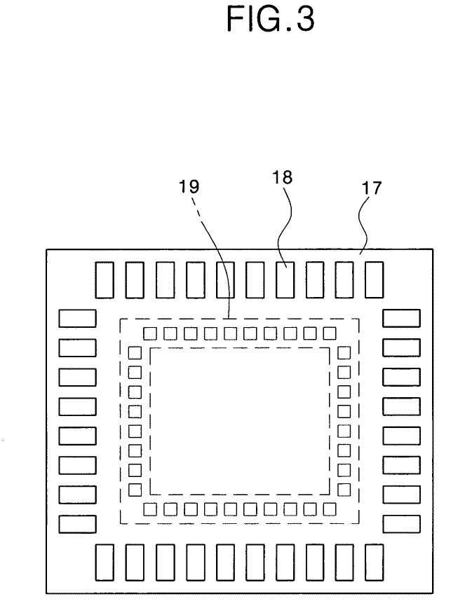

FIG. 1 is a cross-sectional view illustrating an example of a camera module assembled by equipment for assembling a camera module according to an exemplary embodiment of the present invention, FIG. 2 is an exploded cross-sectional view illustrating an example of a camera unit of the camera module of FIG. 1, and FIG. 3 illustrates an example of both the image sensor of FIG. 2 and the bottom surface of a circuit board to which the image sensor is bonded.

Referring to FIGS. 1 through 3, a camera module 10 assembled by equipment for assembling a camera module of the present invention includes a camera unit 11 provided to photograph images and a flexible printed circuit board (FPCB) 20 for electrically connecting the camera unit 11 to a main board of, for instance, a telecommunication terminal. More specifically, the camera unit 11 includes: a lens assembly 12 having both a plurality of lenses 14 receiving light reflected from an object, and a lens barrel 13 fixing the lenses 14, an image sensor 19 bonded on a hard printed circuit board (HPCB) 17 on which a circuit pattern is printed in order to convert the received light into an electrical image signal, and a lens housing 15 for coupling the lens assembly 12, the image sensor 19, and so on.

Accordingly, the camera unit 11 can be assembled by the following exemplary method.

The HPCB 17 is provided with terminals for electrical connection with the image sensor 19 on one surface thereof. A plurality of first bonding pads 18 is formed on the other surface of the HPCB 17 in order to be bonded to the FPCB 20. Thus, the image sensor 19 is bonded to one surface of the HPCB 17 having the terminals. Here, the image sensor 19 can be flip-chip bonded to one surface of the HPCB 17, as illustrated in FIGS. 1 and 2.

After the image sensor 19 is bonded to one surface of the HPCB 17, the lens housing 15 is attached to one surface of the HPCB 17, with the bonded portion of the image sensor 19 facing the top. Here, the image sensor 19 is disposed in the lens housing 15, and the first bonding pads 18 formed on the other surface of the HPCB 17 is exposed from the HPCB 17.

After the lens housing 15 and the HPCB 17 are attached, the lens assembly 12 having the lens barrel 13 into which the lenses 14 are fixed is inserted into the top of the lens housing 15, and then is fixed to the lens housing 15. Thereby, the assembly of the camera unit 11 is completed.

A plurality of second bonding pads 21 may be formed on one surface of one end of the FPCB 20 to be bonded to the first bonding pads 18 provided to the HPCB 17, and a connector 22 is provided on one surface of the other end of the FPCB 20 to be connected to a main board of, for instance, a telecommunication terminal. In this example, the second bonding pads 21, which are formed on one surface of one end of the FPCB 20, are bonded to the first bonding pads 18 that are exposed from the HPCB 17, and the connector 22 is connected to the main board of the telecommunication terminal. Accordingly, the FPCB 20 serves to electrically connect the camera unit 11 to the main board of the telecommunication terminal by means of the bonding and connection.

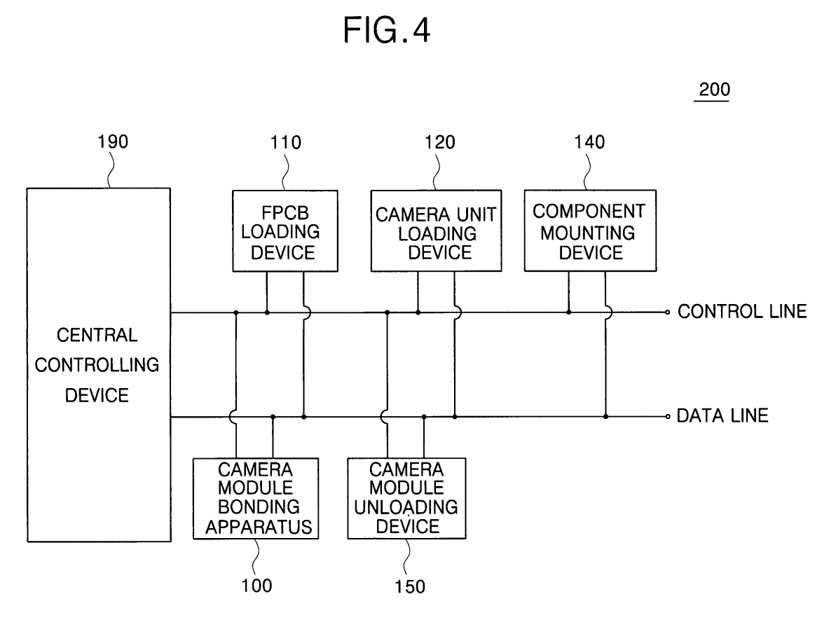

Hereinafter, equipment 200 for assembling a camera module according to an exemplary embodiment of the present invention will be described in detail with reference to FIG. 4.

FIG. 4 is a block diagram illustrating an example of the configuration of equipment for assembling a camera module according to an exemplary embodiment of the present invention.

Referring to FIGS. 1 through 4, equipment 200 for assembling a camera module according to an exemplary embodiment of the present invention is equipment that assembles the camera module 10 by bonding the FPCB 20 to the pre-assembled camera unit 11. The equipment 200 includes an FPCB loading device 110, which conveys a plurality of FPCBs 20 provided from the outside to a previously designated position, for example, a bonding position, and a camera unit loading device 120, which conveys a plurality of camera units 11 provided from the outside to a previously designated position, for example, a bonding position, in a tray arrangement. the equipment 200 further includes a component mounting device 140, which picks up and aligns at least one of the conveyed FPCBs 20, and then mounts the FPCBs 20 above the camera unit 11, or which picks up and aligns at least one of the conveyed camera units 11, and then mounts the camera unit 11 above the FPCB 20, a camera module bonding apparatus 100, which bonds the camera unit 11 to the FPCB 20 using a laser beam; a camera module unloading device 150, which unloads the bonded camera module 10, and a central controlling device 190, which is electrically connected to the devices 110, 120, 140 and 150 to control the devices 110, 120, 140 and 150, and controls overall operation of the camera module assembly equipment 200.

Thus, when the FPCB 20 and the camera unit 11 are conveyed to the bonding position by the FPCB loading device 110 and the camera unit loading device 120 respectively, the component mounting device 140 picks up either the camera unit 11 or the FPCB 20, and then mount it on the other such that the first and second bonding pads 18 and 21 of the conveyed components 11 and 20 are in contact with each other. The camera module bonding apparatus 100 applies the laser beam to a portion where the components 11 and 20 are in contact with each other, thereby bonding the components 11 and 20, for example, the camera unit 11 and the FPCB 20 to each other. After the camera unit 11 and the FPCB 20 are bonded to each other, the camera module unloading device 150 unloads the bonded camera module 10 to a predetermined position, i.e., a camera module loading position.

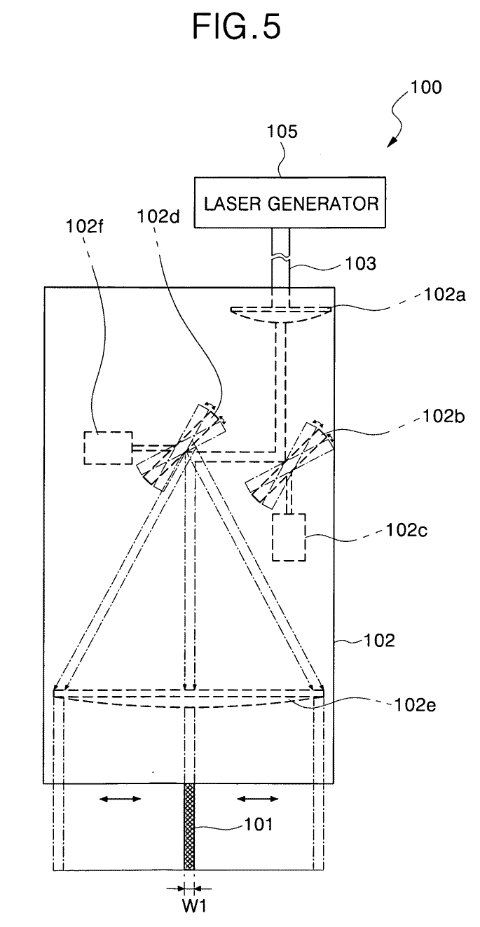

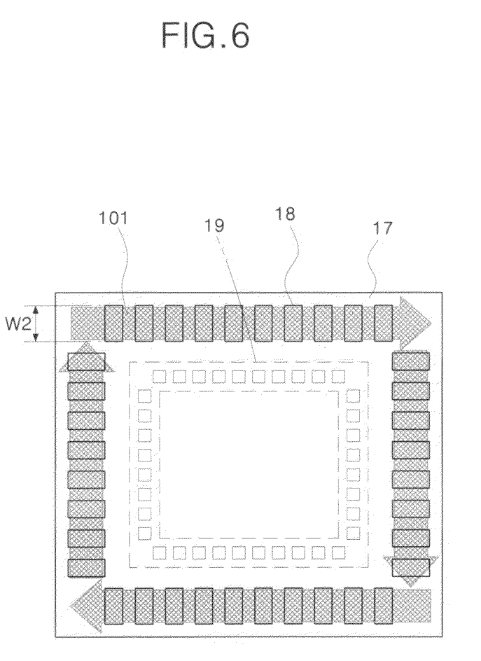

Hereinafter, an example of the camera module bonding apparatus 100 according to an exemplary embodiment of the present invention will be described in detail with reference to FIGS. 5 and 6.

FIG. 5 is a plan view illustrating an exemplary embodiment of the camera module bonding apparatus illustrated in FIG. 4, and FIG. 6 is a bottom view illustrating a method of bonding a camera module using the camera module bonding apparatus of FIG. 5.

Referring to FIGS. 5 and 6, the camera module bonding apparatus 100 according to this exemplary embodiment of the present invention applies a laser beam to the contact portions of the camera unit 11 and the FPCB 20 in order to bond the camera unit 11 and the FPCB 20 to each other when the FPCB 20 is mounted above the camera unit 11 or when the camera unit 11 is mounted above the FPCB 20 such that the bonding pads 18 and 21 are in contact with each other. In this example, the camera module bonding apparatus 100 includes a laser generator 105 which generates a laser beam and applies the laser beam to a bonding head 102, and the bonding head 102, which is connected to the laser generator 105 through an optical fiber 103 and guides the laser beam propagating through the optical fiber 103 to the contact portions of the camera unit 11 and the FPCB 20, such that the camera unit 11 and the FPCB 20 are bonded to each other.

In this example, the laser generator 105 generates a predetermined wavelength of laser beam that can transmit the FPCB 20, and applies the laser beam to the bonding head 102. For example, the laser generator 105 generates a laser beam having a wavelength of 1064 nm, which is specific to silicon (Si)-based materials, and applies the laser beam to the bonding head 102. The bonding head 102 can includes a plurality of scan mirrors 102b and 102d disposed on an optical path between the laser generator 105 and the contact portions to refract the laser beam, which is guided from the laser generator 105 through the optical fiber 103, at a predetermined angle in order to change a position where the laser beam is applied, and a plurality of scan mirror driving units 102c and 102f, which are connected to the respective scan mirrors 102b and 102d in order to drive the scan mirrors 102b and 102d according to the control of the central controlling device 190. The bonding head 102 can further include a focusing lens 102a disposed on an optical path between the laser generator 105 and the scan mirror 102b in order to adjust at least one of width and length of the laser beam propagating through the optical fiber 103, and a linear velocity equalizing lens 102e, which is disposed on an optical path between the scan mirror 102d and the contact portions, and refracts the laser beam such that the laser beam, which is guided to the contact portions, is applied to surfaces of the contact portions with constant or substantially constant linear velocity.

Therefore, the laser beam, which is propagating to the bonding head 102 through the optical fiber 103, may be applied to the contact portions after sequentially passing through the focusing lens 102a, the scan mirrors 102b and 102d, and the linear velocity-equalizing lens 102e, as illustrated in FIG. 5. In other words, the laser beam guided to the bonding head 102 may be adjusted in its width and distance when passing through the focusing lens 102a, and then reflected by the scan mirrors 102b and 102d to be refracted at a predetermined angle. Thereafter, the laser beam refracted by the scan mirrors 102b and 102d may be finally applied to the contact portions through the linear velocity-equalizing lens 102e. As described above, the linear velocity-equalizing lens 102e may refract the laser beam such that the laser beam guided to the contact portions can be applied to the surfaces of the contact portions with constant or substantially constant linear velocity, and may include an F-THETA lens. When the first and second bonding pads 18 and 21 come into contact with each other, a laser beam 101 may be 25 applied to the contact portions of the first and second bonding pads 18 and 21 on a side of the other surface of the FPCB 20, on which the second bonding pads 21 are not formed, so that the camera unit 11 and the FPCB 20 can be bonded to each other.

A width W1 of the laser beam 101 applied from the bonding head 102 may be equal or similar to a width W2 of the second bonding pad 21 as illustrated in FIG. 6. Moreover, the scan mirror driving units 102c and 102f can rotate the respective scan mirrors 102b and 102d at a predetermined angle such that the laser beam 101 guided from the bonding head 102 is applied to all of the second bonding pads. In other words, the camera module bonding apparatus 100 can apply the laser beam 101 to all the bonding pads 21 of the FPCB 20 using the scan mirrors 102b and 102d installed on the bonding head 102, and the scan mirror driving units 102c and 102f connected to the scan mirrors 102b and 102d in a scanning fashion, thereby heating the first and second bonding pads 18 and 21 and bonding the camera unit 11 to the FPCB 20.

In an exemplary embodiment as illustrated in FIG. 3, in the case where the first bonding pads 18 are formed along an edge of the HPCB 17, and in the case where the second bonding pads 21 to be bonded to the first bonding pads 18 are formed along an edge of the FPCB 20, the camera module bonding apparatus 100 scans the laser beam 101 along the edges on which the first and second bonding pads 18 and 21 are formed at a constant or substantially constant velocity using the scan mirrors 102b and 102d installed on the bonding head 102, and the scan mirror driving units 102c and 102f connected to the scan mirrors 102b and 102d, as illustrated in FIG. 6, so that it can selectively apply the laser beam 101 only to the edges, heat the first and second bonding pads18 and 21, and bond the camera unit 11 to the FPCB 20. If the scan velocity is fast, the laser beam 101 produces a spot locus along a scan path. This can have a similar effect to the case in which the laser beam 101 is applied to the applied portion en bloc. Accordingly, the bonding portions for heating, for example, the contact portions of the first and second bonding pads 18 and 21 can be selectively heated using the camera module bonding apparatus 100 according to an exemplary embodiment of the present invention.

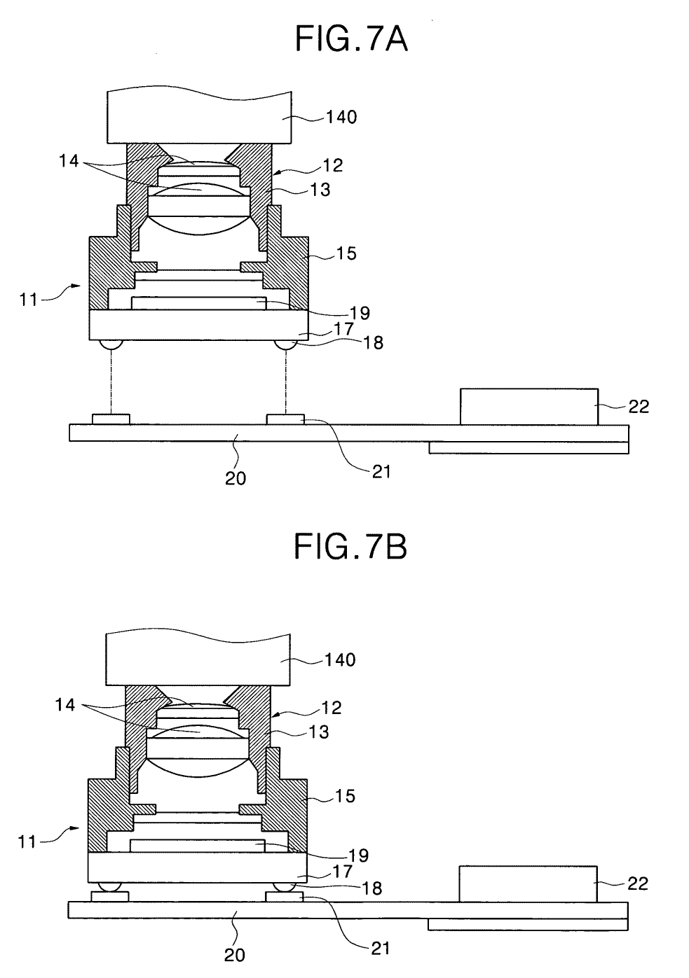

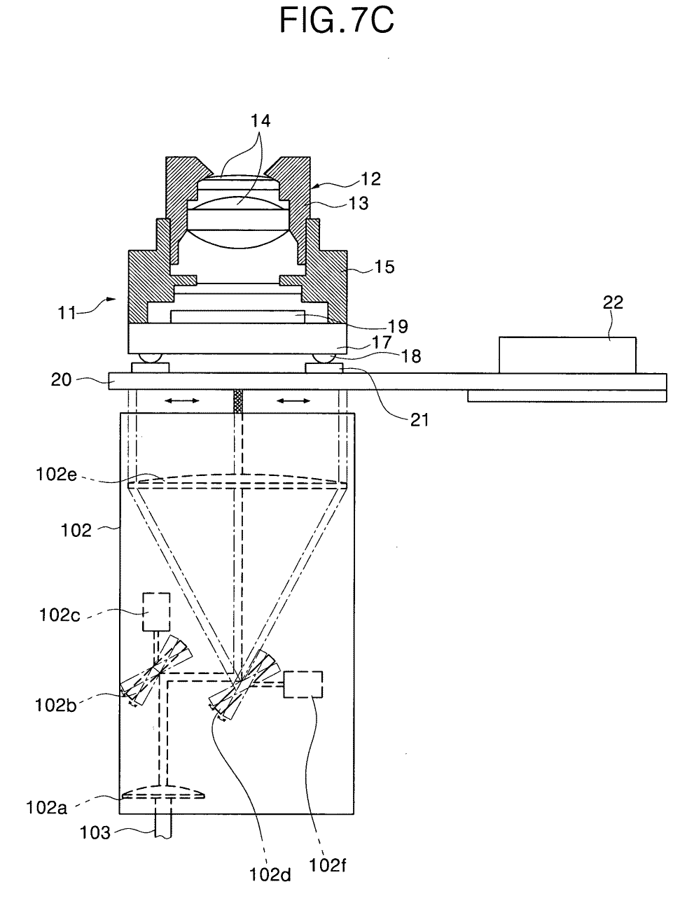

Hereinafter, an example of a method of assembling the camera module 10 using both the camera module bonding apparatus 100 according to an exemplary embodiment of the present invention and the component-mounting device 140 will lo be described in detail with reference to FIGS. 7A through 7C.

FIGS. 7A through 7C are flowcharts illustrating an example of a method of assembling a camera module using both the camera module bonding apparatus and the component-mounting device illustrated in FIG. 5. More specifically, FIG. 7A illustrates an example of the step in which the component-mounting device picks up a camera unit conveyed from the camera unit loading device and aligns it with the FPCB conveyed by the FPCB loading device, FIG. 7B illustrates an example of the step in which the component-mounting device mounts the aligned camera unit above the FPCB, and FIG. 7C illustrates an example of the step in which the camera module bonding apparatus applies a laser beam to the contact portions of the camera unit and the FPCB such that the camera unit and the FPCB are bonded to each other.

As illustrated in FIGS. 7A through 7C, when the FPCB 20 and the camera unit 11 are conveyed to the bonding position by the FPCB loading device and the camera unit loading device respectively, the component-mounting device 140 picks up the camera unit 11 and conveys it above the FPCB 20. Then, the component-mounting device 140 aligns the camera unit 11 with the FPCB 20 such that the first bonding pads 18 of the HPCB 17 are exactly in contact with the second bonding pads 21 of the FPCB 20.

Next, when the camera unit 11 is aligned with the FPCB 20, the component-mounting device 140 mounts the aligned camera unit 11 above the FPCB 20. Here, the first bonding pads 18 of the HPCB 17 on the camera unit 11 are exactly in contact with upper surfaces of the second bonding pads 21 of the FPCB 20. In this example, the first bonding pads 18 of the HPCB 17 and the second bonding pads 21 of the FPCB 20 are previously covered with a flux in order to prevent an oxide layer from being formed thereon to thereby increase bondability. Thus, when mounted above the FPCB 20, the camera unit 11 can continue to be mounted above the FPCB 20 maintained for a predetermined time due to viscosity of the previously applied flux.

Afterwards, when the camera unit 11 is mounted above the FPCB 20, the bonding head 102 of the camera module bonding apparatus 100 applies the laser beam 101 to the contact portion of the first and second bonding pads 18 and 21 from the lower side of the FPCB 20, i.e., the side on which the second bonding pads 21 are not formed. As illustrated in FIG. 6, since a width W1 of the laser beam 101 applied from the bonding head 102 is equal or similar to a width W2 of each second bonding pad 21, the camera module bonding apparatus 100 rotates the scan mirrors 102b and 102d using the scan mirror driving units 102c and 102f installed on the bonding head 102 such that the laser beam 101 applied from the bonding head 102 is applied to all of the second bonding pads 21.

Thus, the laser beam 101 guided from the bonding head 102 is applied to all of the second bonding pads 21, particularly, all of the contact portions of the first and second bonding pads 18 and 21. As a result, the first and second bonding pads 18 and 21, to which the laser beam 101 is applied, quickly reach their melting points. Thereby, the first and second bonding pads 18 and 21 melt together. Here, the camera unit 11 moves down toward the FPCB 20 under its own weight, so that it is bonded to the FPCB 20 by the alloyed first and second bonding pads 18 and 21.

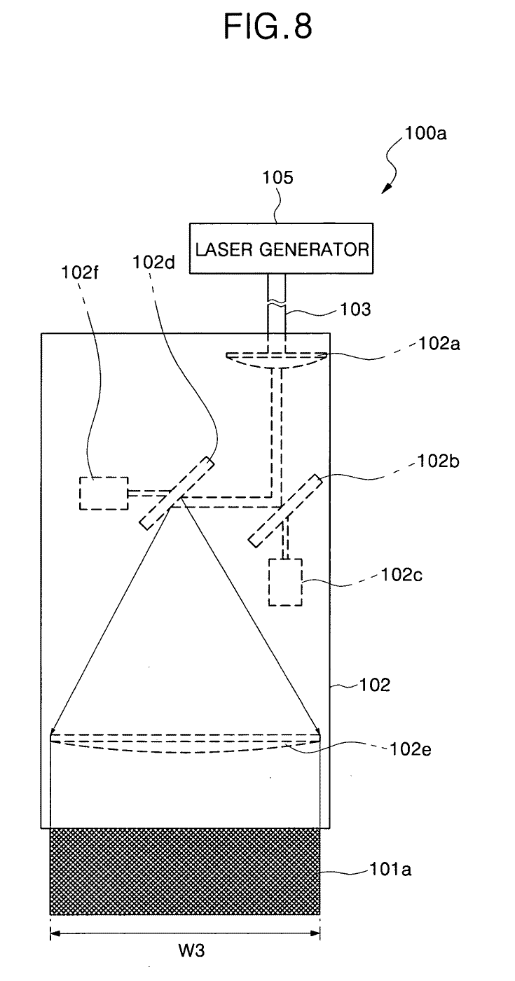

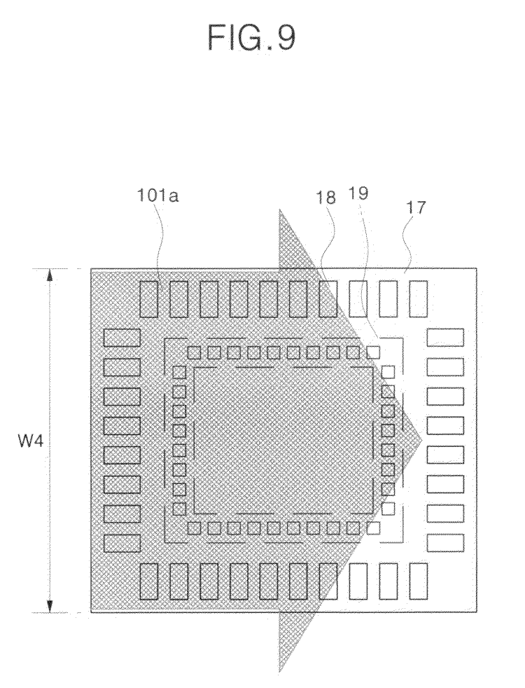

Hereinafter, an example of a camera module bonding apparatus 100a according to another exemplary embodiment of the present invention will be described in detail with reference to FIGS. 8 and 9.

FIG. 8 is a perspective view illustrating an example of a camera module bonding apparatus according to a second exemplary embodiment of the present invention, and FIG. 9 is a bottom view illustrating an example of a method of bonding a camera module using the camera module bonding apparatus illustrated in FIG. 8; Referring to FIG. 8, the camera module bonding apparatus 100a according to a second exemplary embodiment of the present invention has the same configuration as the camera module bonding apparatus 100 according to the exemplary embodiment discussed above. The camera module bonding apparatus 100a according to the this exemplary embodiment of the present invention includes a laser generator 105, which generates a laser beam and emits it to a bonding head 102, and the bonding head 102 which is connected to the laser generator 105 through an optical fiber 103 and applies the laser beam propagating through the optical fiber 103 to contact portions of the camera unit 11 and the FPCB 20 such that the camera unit 11 and the FPCB 20 are bonded to each other.

In this example, the bonding head 102 includes a plurality of scan mirrors 102b and 102d, which are disposed on an optical path between the laser generator 105 and the contact portions of the camera unit 11 and the FPCB 20, and refract the laser beam propagating from the laser generator 105 through the optical fiber 103 at a predetermined angle such that a position of the applied laser beam is changed, and scan mirror driving units 102c and 102f, which are connected to the respective scan mirrors 102b and 102d in order to drive the scan mirrors 102b and 102d under the control of, for instance, the aforementioned central controlling device 190. The bonding head 102 further comprises a focusing lens 102a, which is disposed on an optical path between the laser generator 105 and the scan mirror 102b in order to adjust at least one of width and length of the laser beam propagating through the optical fiber 103, and a linear velocity equalizing lens 102e, which is disposed on an optical path between the scan mirror 102d and the contact portions of the camera unit 11 and the FPCB 20, and refracts the laser beam applied to the contact portions such that the laser beam travels toward surfaces of the contact portions with constant or substantially constant linear velocity.

As illustrated in FIG. 8, the camera module bonding apparatus 100a according to this exemplary embodiment of the present invention makes a width W3 of the applied laser beam wider using the scan mirror driving units 102c and 102f and the scan mirrors 102b and 102d connected to the scan mirror driving units 120c and 120f, all of which are installed on the bonding head 102. That is, the camera module bonding apparatus 100a according to this exemplary embodiment of the present invention rotates the scan mirrors 102b and 102d connected to the scan mirror driving units 102c and 102f, at a higher speed by, for instance, reciprocation using the scan mirror driving units 102c and 102f installed on the bonding head 102, so that the width W3 of the applied laser beam becomes equal or similar to a width W4 of the FPCB 20, as illustrated in FIGS. 8 and 9. Thus, the bonding process is carried out using the laser beam having this width W3.

In other words, the camera module bonding apparatus 100a according to the this exemplary embodiment of the present invention forms the width W3 of the applied laser beam to be equal or similar to the width W4 of the FPCB 20, and moves the laser beam 101a in a lengthwise direction of the FPCB 20 in a scanning fashion in the state where the laser beam 101a maintains the width W3, as illustrated in FIG. 9, thereby causing the laser beam 101a applied from the bonding head 102 to be applied to all of the second bonding pads 21 formed on the FPCB 20. Thus, the camera module bonding apparatus 100a heats the first and second bonding pads 18 and 21 and bonds the camera unit 11 to the FPCB 20.

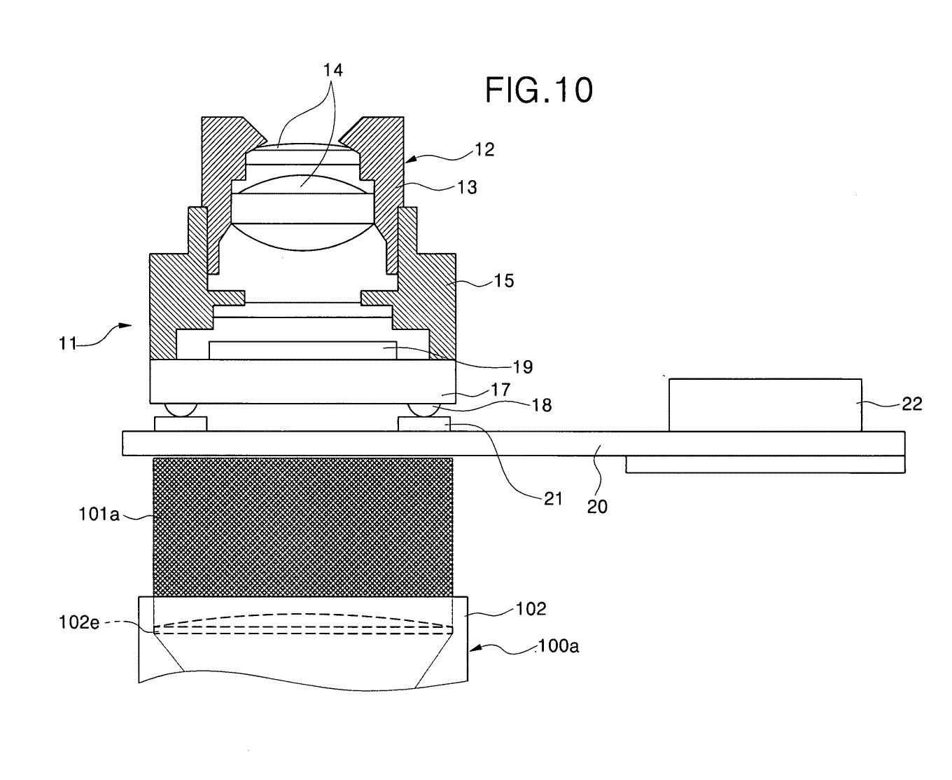

Now, an example of a method of assembling the camera module 10 using both the camera module bonding apparatus 100a according to the second exemplary embodiment of the present invention and the component-mounting device 140 will be described in detail with reference to FIGS. 7A, 7B and 10. FIG. 10 is a side view illustrating an example of a method of bonding a camera module using the camera module bonding apparatus illustrated in FIG. 8.

As illustrated in FIGS. 7A, 7B and 10, when the FPCB 20 and the camera unit 11 are conveyed to the bonding positions by the FPCB loading device and the camera unit loading device respectively, the component-mounting device 140 picks up the camera unit 11, conveys it above the FPCB 20, and aligns it with the FPCB such that the first bonding pads 18 of the HPCB 17 provided to the camera unit 11 are exactly in contact with the second bonding pads 21 of the FPCB 20. Next, when the camera unit 11 and the FPCB 20 are aligned with each other, the component-mounting device 140 mounts the aligned camera unit 11 above the FPCB 20. At this time, the first bonding pads 18 of the HPCB 17 are exactly in contact with the second bonding pads 21 of the FPCB 20.

Subsequently, when the camera unit 11 is mounted above the FPCB 20, the bonding head 102 of the camera module bonding apparatus 100a applies the laser beam 101a to the contact portions of the first and second bonding pads 18 and 21 from the lower side of the FPCB 20. As illustrated in FIG. 9, since the width W3 of the laser beam applied from the bonding head 102 is equal or similar to the width W4 of the FPCB 20, the camera module bonding apparatus 100a moves the laser beam 101a in a lengthwise direction of the FPCB 20 in a scanning fashion in the state where the laser beam 101a maintains the width W3 as illustrated in FIG. 9, thereby causing the laser beam 101a applied from the bonding head 102 to be applied to all of the second bonding pads 21 formed on the FPCB 20. As a result, the laser beam 101a applied from the bonding head 102 is applied to all of the second bonding pads 21, particularly to all of the contact portions of the first and second bonding pads 18 and 21, so that the camera unit 11 and the FPCB 20 are bonded to each other by fusion of the first and second bonding pads 18 and 21.

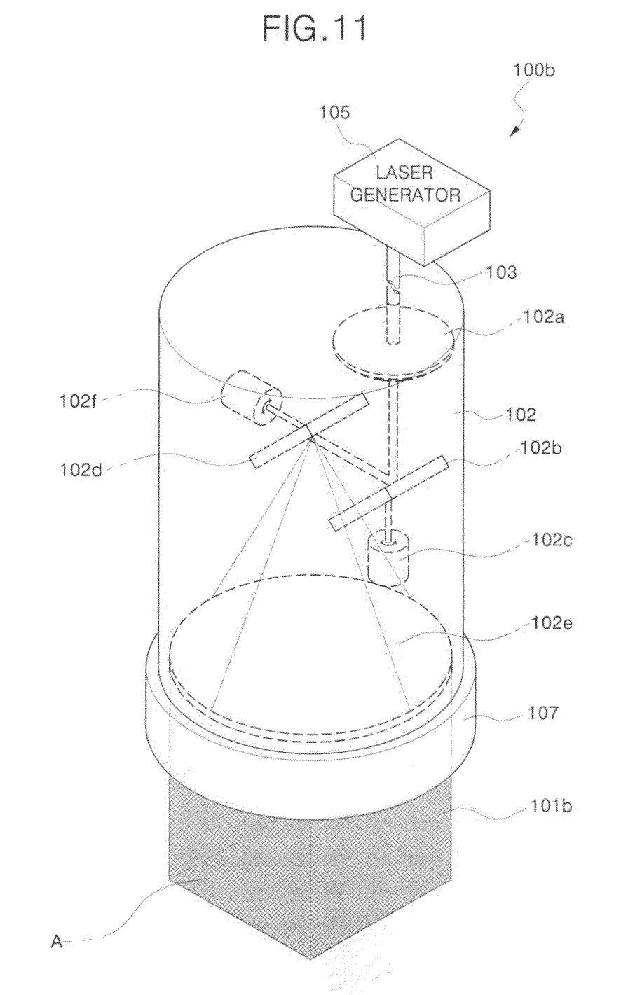

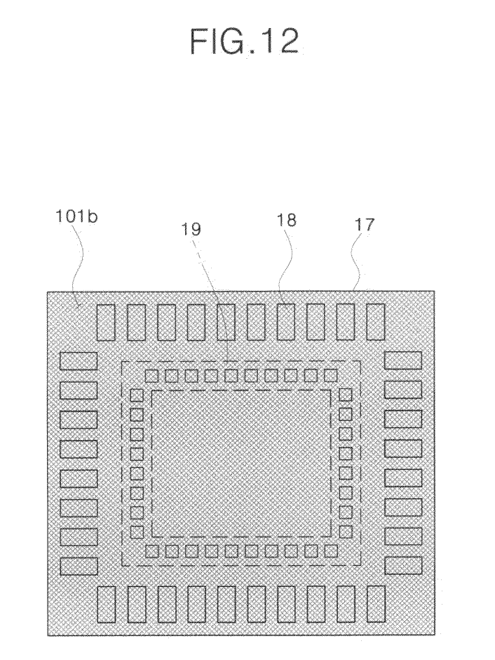

Hereinafter, an example of a camera module bonding apparatus 100b according to another exemplary embodiment of the present invention will be described in detail with reference to FIGS. 11 and 12. FIG. 11 is a perspective view of an example of a camera module bonding apparatus according to a third exemplary embodiment of the present invention, and FIG. 12 is a bottom view illustrating an example of a method of bonding a camera module using the camera module bonding apparatus illustrated in FIG. 11.

Referring to FIG. 11, the camera module bonding apparatus 100b according to this exemplary embodiment of the present invention includes a laser generator 105, which generates a laser beam, and emits it to a bonding head 102, the bonding head 102, which is connected to the laser generator 105 through an optical fiber 103 and applies the laser beam propagating through the optical fiber 103 to contact portions of the camera unit 11 and the FPCB 20 such that the camera unit 11 and the FPCB 20 are bonded to each other, and a pressing tool 107 disposed between the contact portions and the bonding head 102 to press the contact portions of the camera unit 11 and the FPCB 20, and formed of a transparent material such that the laser beam 101b applied from the bonding head 102 is transmitted.

In this example, the bonding head 102 includes a plurality of scan mirrors 102b and 102d, which are disposed on an optical path between the laser generator 105 and the contact portions of the camera unit 11 and the FPCB 20, and refract the laser beam propagating from the laser generator 105 through the optical fiber 103 at a predetermined angle such that a position of the applied laser beam is changed, and scan mirror driving units 102c and 102f, which are connected to the respective scan mirrors 102b and 102d, and drive the scan mirrors 102b and 102d under the control of, for instance, the central controlling device 190. The bonding head 102 further includes a focusing lens 102a, which is disposed on an optical path between the laser generator 105 and the scan mirror 102b in order to adjust at least one of width and length of the laser beam propagating through the optical fiber 103, and a linear velocity-equalizing lens 102e, which is disposed on an optical path between the scan mirror 102d and the contact portions of the camera unit 11 and the FPCB 20, and refracts the laser beam 101a such that the laser beam applied to the contact portions travels toward the contact portions with constant or substantially constant linear velocity. Thus, the laser beam 101a is applied to the contact portions of the camera unit 11 and the FPCB 20 such that an application area A of the laser beam is equal or similar to the area of the HPCB 17 as illustrated in FIG. 12.

In other words, the camera module bonding apparatus 100b according to this exemplary embodiment of the present invention rotates the scan mirrors 102b and 102d, which are connected to the scan mirror driving units 102c and 102f, at a higher speed by, for instance, reciprocation using the scan mirror driving units 102c and 102f installed on the bonding head 102, so that the application area A of the laser beam is equal or similar to the area of the HPCB 17, as illustrated in FIG. 12. Thus, the bonding process is carried out using the applied laser beam having the application area A.

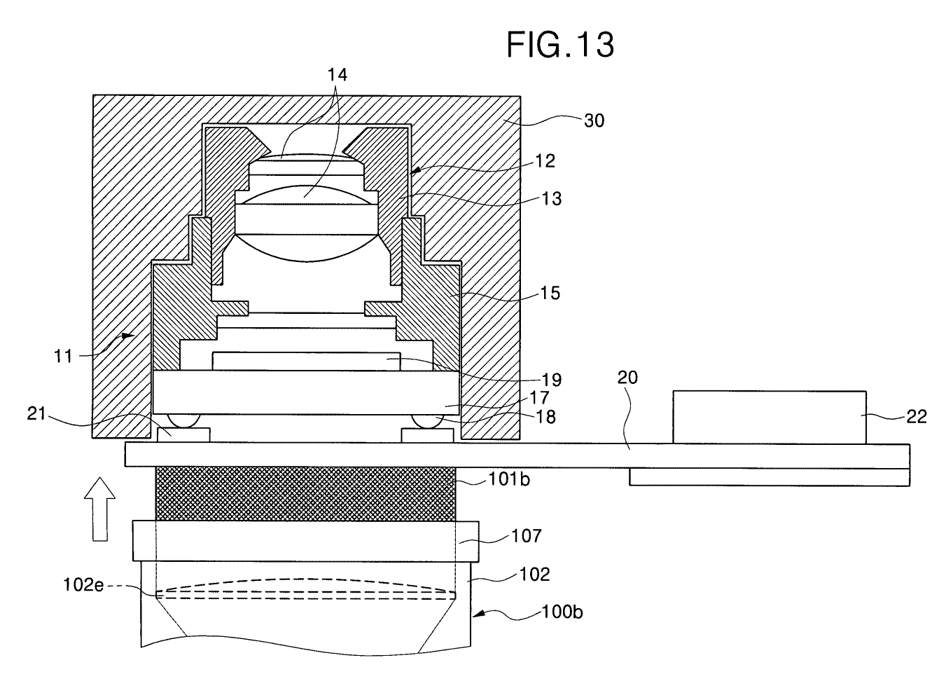

Hereinafter, an example of a method of assembling a camera module 10 using both the camera module bonding apparatus 100b according to this exemplary embodiment of the present invention and the component-mounting device 140 will be described in detail with reference to FIGS. 7A, 7B and 13. FIG. 13 is a side view illustrating an example of a method of bonding a camera module using the camera module bonding apparatus illustrated in FIG. 11.

As illustrated in FIGS. 7A, 7B and 13, when the FPCB 20 and camera unit 11 are conveyed to bonding positions by the FPCB loading device and the camera unit loading device respectively, the component-mounting device 140 picks up the camera unit 11, conveys it above the FPCB 20, and aligns it with the FPCB 20 such that the first bonding pads 18 of the HPCB 17 provided to the camera unit 11 are exactly in contact with the second bonding pad 21s of the FPCB 20. When the camera unit 11 and the FPCB 20 are aligned with each other, the component-mounting device 140 mounts the aligned camera unit 11 above the FPCB 20. The first bonding pads 18 of the HPCB 17 provided to the camera unit 11 are exactly in contact with upper surfaces of the second bonding pads 21 of the FPCB 20. Next, when the camera unit 11 is mounted above the FPCB 20 and the first bonding pads 18 of the camera unit 11 are exactly in contact with the upper surfaces of the second bonding pad 21 of the FPCB 20, the bonding head 102 of the camera module bonding apparatus 100b applies the laser beam 101b to the contact portions of the first and second bonding pads 18 and 21 while pressing the contact portions of the camera unit 11 and the FPCB 20, for example, the contact portions of the first and second bonding pads 18 and 21 on the lower side of FPCB 20 using the pressing tool 107 disposed between the contact portions and the bonding head 102.

As illustrated in FIG. 12, since the application area A of the laser beam 101b applied from the bonding head 102 is equal or similar to the area of the HPCB 17, the laser beam 101b applied from the bonding head 102 is applied to all of the second bonding pads 21 formed on the FPCB 20 at a higher speed. Accordingly, the first and second bonding pads 18 and 21, which are in contact with each other, are rapidly heated and melted by the application of the laser beam 101b, so that the camera unit 11 and the FPCB 20 are rapidly bonded to each other by the application of the laser beam 101b as well as by the pressing force of the pressing tool 107. Reference number 30 represents a jig, which is disposed around the camera unit 11 in order to support the camera unit 11 pressed by the pressing tool 107 when the camera module bonding apparatus 100b applies the laser beam.

When the camera unit 11 and the FPCB 20 are bonded to each other by the camera module assembling method according to the present invention, the laser beam applied to the contact portions of the camera unit 11 and the FPCB 20 can melt the first and second bonding pads 18 and 21 of the camera unit 11 and the FPCB 20. As such, it takes a very short time to press and heat the contact portions of the first and second bonding pads 18 and 21 of the camera unit 11 and the FPCB 20. Accordingly, in the camera module assembling method according to the present invention, although the contact portions of the first and second bonding pads 18 and 21 of the camera unit 11 and the FPCB 20 are pressed, there is no deformation of either a lens barrel or a lens housing, and no lens focusing failure resulting from deformation, etc., unlike in the prior art.

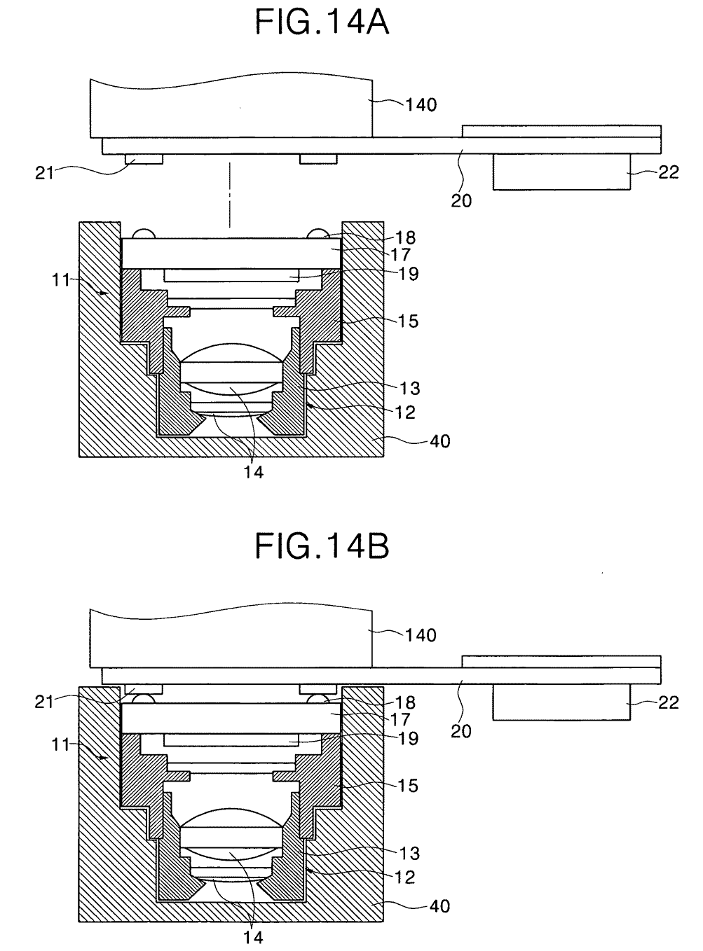

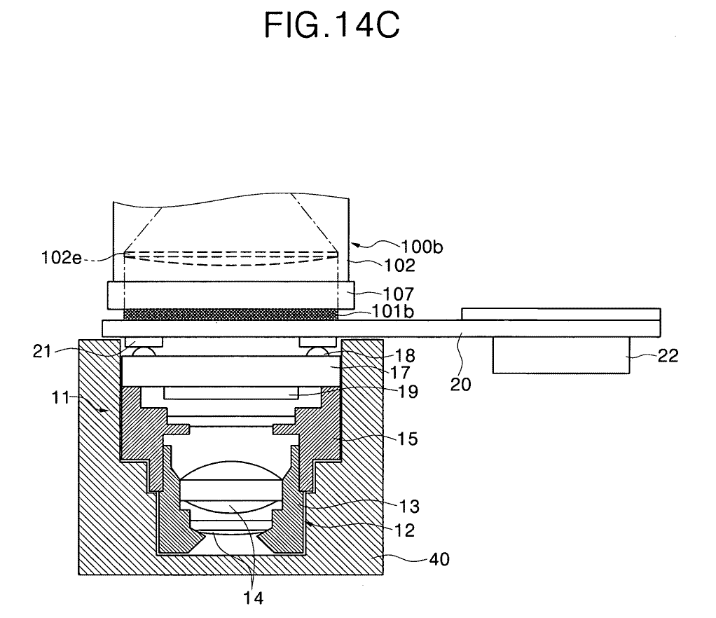

Hereinafter, another method of assembling a camera module 10 using both the camera module bonding apparatus 100b according to this exemplary embodiment of the present invention and the component-mounting device 140 will be described in detail with reference to FIGS. 14A through 14C.

FIGS. 14A through 14C are diagrams illustrating an example of a method of assembling a camera module using both the camera module bonding apparatus illustrated in FIG. 11 and a component-mounting device. More specifically, FIG. 14A illustrates an example of the step in which the component-mounting device picks up an FPCB and aligns it with a camera unit, FIG. 14B illustrates an example of the step in which the component-mounting device mounts the aligned FPCB above the camera unit, and FIG. 14C illustrates an example of the step in which the camera module bonding apparatus applies a laser beam to contact portions of the FPCB and the camera unit such that the camera unit and the FPCB are bonded to each other.

As illustrated in FIGS. 14A through 14C, when the FPCB 20 and the camera unit 11 are conveyed to bonding positions by the FPCB loading device and the camera unit loading device respectively, the component-mounting device 140 picks up the FPCB 20, conveys the FPCB 20 above the camera unit 11, and aligns the FPCB 20 with the camera unit 11 such that the second bonding pads 21 of the FPCB 20 are exactly in contact with the first bonding pads 18 of the camera unit 11. Next, when the FPCB 20 and the camera unit 11 are aligned with each other, the component-mounting device 140 mounts the aligned FPCB 20 above the camera unit 11. In this example, the second bonding pads 21 of the FPCB 20 are exactly in contact with upper surfaces of the first bonding pads 18 of the camera unit 11.

Subsequently, when the FPCB 20 is mounted above the camera unit 11 and the second bonding pads 21 of the FPCB 20 are exactly aligned and in contact with the upper surfaces of the first bonding pads 18 of the camera unit 11, the bonding head 102 of the camera module bonding apparatus 100b applies the laser beam 101b to the contact portions of the camera unit 11 and the FPCB 20, while pressing the contact portions of the camera unit 11 and the FPCB 20, for example, the contact portions of the first and second bonding pads 18 and 21 on the upper side of the FPCB 20 using the pressing tool 107 disposed between the contact portions and the bonding head 102. At this time, since the application area A of the laser beam 101b applied from the bonding head 102 is equal or similar to an area of the HPCB 17 as illustrated in FIG. 12, the laser beam 101b applied from the bonding head 102 is applied to all of the second bonding pads 21 formed on the FPCB 20 at a higher speed.

Accordingly, the second bonding pads 21 and the first bonding pads 18, which are in contact with each other, are quickly heated and melted by the application of the laser beam 101b, and both the FPCB 20 and the camera unit 11 are quickly bonded to each other by the application of the laser beam 101b and the pressing force of the pressing tool 107. Reference number 40 indicates a jig, which is disposed around the camera unit 11 in order to support the camera unit 11 pressed by the pressing tool 107 when the camera module bonding apparatus 100b applies the laser beam.

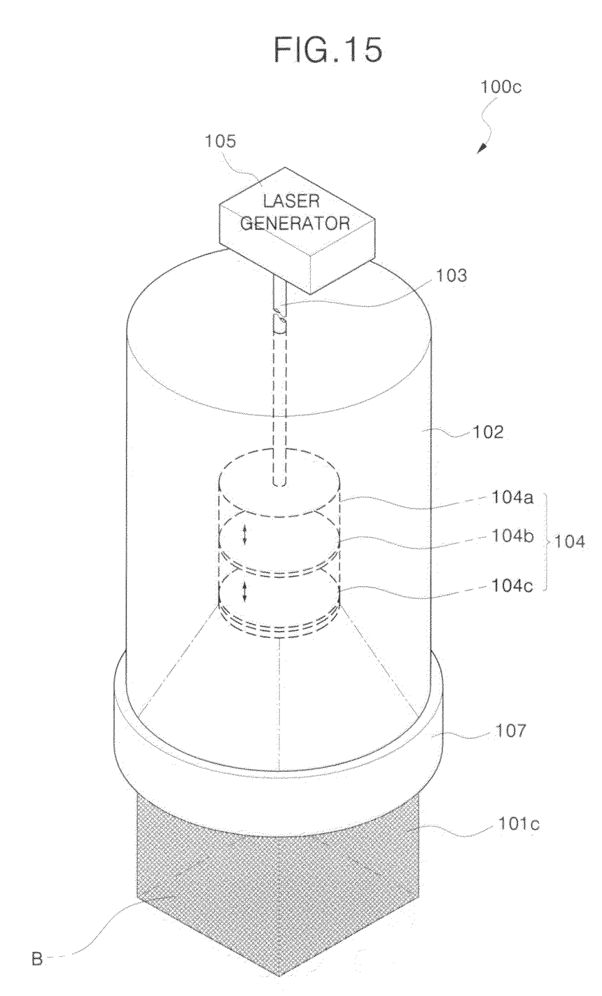

Now, an example of a camera module bonding apparatus 100c according to a further exemplary embodiment of the present invention will be described in detail with reference to FIG. 15. FIG. 15 is a perspective view of an example of a camera module bonding apparatus according to a fourth exemplary embodiment of the present invention.

Referring to FIG. 15, the camera module bonding apparatus 100c according to the fourth exemplary embodiment of the present invention has a configuration lo similar to that of the camera module bonding apparatus 100b according to the exemplary embodiment discussed above. The camera module bonding apparatus 100c according to this exemplary embodiment of the present invention includes a laser generator 105, which generates a laser beam, and emits it to a bonding head 102, the bonding head 102, which is connected to the laser generator 105 through the optical fiber 103, and applies the laser beam to contact portions of the camera unit 11 and the FPCB 20, and a pressing tool 107 disposed between the contact portions and the bonding head 102 so as to press the contact portions of the camera unit 11 and the FPCB 20, and formed of a transparent material such that a laser beam 101c applied from the bonding head 102 is transmitted. However, the bonding head 102 of the camera module bonding apparatus 100c according to this exemplary embodiment of the present invention has a different configuration from that of the third exemplary embodiment.

As illustrated in FIG. 15, the bonding head 102 of the camera module bonding apparatus 100c according to this exemplary embodiment of the present invention is disposed on an optical path between both the laser generator 105 and the contact portions, and is provided therein with a laser optical system 104 so as to adjust an application area B of the laser beam 101c propagating through the optical fiber 103. Accordingly, the laser beam emitted from the laser generator 105 is adjusted to a predetermined size of application area B (FIG. 15) while passing through the laser optical system 104 of the bonding head 102, and then is applied to a lower side of the bonding head 102, for example, the contact portions of the camera unit 11 and the FPCB 20. Thereby, the contact portions of the camera unit 11 and the FPCB 20 are heated and bonded to each other by the application of the laser beam 101c.

As illustrated in FIG. 12, the laser optical system 104 can adjust the application area B such that the application area B is equal or similar to the area of the HPCB 17. In this case, since the application area B of the laser beam 101c, which is adjusted by the laser optical system 104 when applied from the bonding head 102, is equal or similar to the area of the HPCB 17 as illustrated in FIG. 12, Is the laser beam 101c applied from the bonding head 102 can heat all of the second bonding pads 21 of the FPCB 20 at a higher speed. Accordingly, the second bonding pads 21 and the first bonding pads 18, which are in contact with each other, can be heated and melted by the application of the laser beam 101c at a higher speed, so that the camera unit 11 and the FPCB 20 can bonded at a higher speed by pressing force of the pressing tool 107 together with the application of the laser beam 101c.

In this example, the laser optical system 104 is configured to properly adjust the application area B of the laser beam 101c, and thus can be variously modified or changed. As an example, the laser optical system 104 may include a lens barrel 104a, a first focusing lens 104b, which is installed in the lens barrel 104a to be able to move in a lengthwise direction and adjusts one of width or length of the laser beam propagating through the optical fiber 103, and a second focusing lens 104c, which adjusts the other one of the width and length of the laser beam propagating through the optical fiber 103.

According to the embodiments of the present invention described herein, a laser beam is applied to contact portions of a camera unit and an FPCB, so that the contact portions can be heated and bonded to each other. Thus, a process of bonding a camera module can be performed within a relatively short time compared to the case where a hot-bar or an oven is used. Accordingly, various problems occurring when a conventional process of bonding a camera module is performed, for example, the focusing failure of lenses resulting from the deformation of a lens barrel or a lens housing, the contamination of am image sensor or a lens by vapor or particles occurring in an oven, and so on, can be resolved. Furthermore, for example, only pads for bonding the camera unit and the FPCB can be selectively heated through adjustment of, for instance, the width of the applied laser beam, so that thermal problems associated with the bonding of the camera module can be efficiently resolved.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. An apparatus for bonding a camera module, comprising:
a laser generator, which generates a laser beam; and
a bonding head, which is connected to the laser generator through an optical fiber and applies the laser beam propagating through the optical fiber to contact portions of a camera unit having an image sensor and lenses and a flexible printed circuit board (FPCB) electrically connected to the image sensor, such that the camera unit and the FPCB are bonded to each other.

2. The apparatus of claim 1, wherein the bonding head is disposed on an optical path between the laser generator and the contact portions, and comprises at least one scan mirror, which refracts the laser beam emitted from the laser generator such that a position of the applied laser beam is changed.

3. The apparatus of claim 2, wherein the bonding head further comprises a focusing lens, which is disposed on an optical path between the laser generator and the scan mirror in order to adjust at least one of width and length of the laser beam propagating through the optical fiber, and a linear velocity-equalizing lens, which is disposed on an optical path between the scan mirror and the contact portions and refracts the laser beam such that the laser beam applied to the contact portions is applied to surfaces of the contact portions with substantially constant linear velocity.

4. The apparatus of claim 1, further comprising a pressing tool disposed between the contact portions and the bonding head to press the contact portions and made of a transparent material such that the laser beam applied from the bonding head is transmitted.

5. The apparatus of claim 1, wherein:
the camera unit further comprises a hard printed circuit board (HPCB) having a plurality of first bonding pads such that the image sensor is bonded to one surface thereof and the FPCB is bonded to the other surface thereof;
the FPCB comprises a plurality of second bonding pads on one surface thereof to be bonded to the first bonding pads; and
the bonding head applies the laser beam to contact portions of the bonding pads from a side of the other surface of the FPCB when the first bonding pads and the second bonding pads come into contact with each other.

6. The apparatus of claim 5, wherein:
the first bonding pads and the second bonding pads are formed at edges of the HPCB and the FPCB, respectively; and
the bonding head applies the laser beam to the edges at which the bonding pads are formed.

7. The apparatus of claim 5, wherein the bonding head applies the laser beam having a predetermined width to the contact portions of the bonding pads, the width of the applied laser beam being equal or similar to that of either each second bonding pad or the FPCB.

8. The apparatus of claim 5, wherein the bonding head applies the laser beam having a predetermined area to the contact portions of the bonding pads, the area of the applied laser beam being equal or similar to that of the other surface of the HPCB.

9. Equipment for assembling a camera module, comprising:
a component-mounting device, which mounts a flexible printed circuit board (FPCB) electrically connected to an image sensor above a camera unit having the image sensor and lenses, or which mounts the camera unit above the FPCB; and
a camera module bonding apparatus, which bonds the camera unit and the FPCB mounted by the component-mounting device using a laser beam, and comprises a laser generator, which generates a laser beam, and a bonding head, which is connected to the laser generator through an optical fiber and applies the laser beam propagating through the optical fiber to contact portions of the camera unit and the FPCB, such that the camera unit and the FPCB are bonded to each other.

10. The equipment of claim 9, wherein the bonding head is disposed on an optical path between the laser generator and the contact portions, and comprises at least one scan mirror, which refracts the laser beam emitted from the laser generator such that a position of the applied laser beam is changed.

11. The equipment of claim 10, wherein the bonding head further comprises a focusing lens, which is disposed on an optical path between the laser generator and the scan mirror in order to adjust at least one of width and length of the laser beam propagating through the optical fiber, and a linear velocity-equalizing lens, which is disposed on an optical path between the scan mirror and the contact portions and refracts the laser beam such that the laser beam applied to the contact portions is applied to surfaces of the contact portions with substantially constant linear velocity.

12. The equipment of claim 9, wherein the camera module bonding apparatus further comprises a pressing tool disposed between the contact portions and the bonding head to press the contact portions and made of a transparent material such that the laser beam applied from the bonding head is transmitted.

13. The equipment of claim 9, wherein:
the camera unit further comprises a hard printed circuit board (HPCB) having a plurality of first bonding pads such that the image sensor is bonded to one surface thereof and the FPCB is bonded to the other surface thereof;
the FPCB comprises a plurality of second bonding pads on one surface thereof to be bonded to the first bonding pads; and
the bonding head applies the laser beam to contact portions of the bonding pads from a side of the other surface of the FPCB when the first bonding pads and the second bonding pads come into contact with each other.

14. The equipment of claim 13, wherein:
the first bonding pads and the second bonding pads are formed at edges of the HPCB and the FPCB, respectively; and
the bonding head applies the laser beam to the edges at which the bonding pads are formed.

15. The equipment of claim 13, wherein the bonding head applies the laser beam having a predetermined width to the contact portions of the bonding pads, the width of the applied laser beam being equal or similar to that of either each second bonding pad or the FPCB.

16. The equipment of claim 13, wherein the bonding head applies the laser beam having a predetermined area to the contact portions of the bonding pads, the area of the applied laser beam being equal or similar to that of the other surface of the HPCB.

17. A method of assembling a camera module, comprising:
mounting a flexible printed circuit board (FPCB) electrically connected to an image sensor above a camera unit having the image sensor and lenses using a component-mounting device, or mounting the camera unit above the FPCB using the component-mounting device; and
applying a laser beam to contact portions of the camera unit and the FPCB, such that the camera unit and the FPCB are bonded to each other using a camera module bonding apparatus including a laser generator and a bonding head to which the laser beam is guided from the laser generator.

18. The method of claim 17, further comprising refracting the laser beam guided from the laser generator using at least one scan mirror installed on the bonding head such that a position of the applied laser beam is changed.

19. The method of claim 17, wherein the bonding comprises adjusting at least one of width and length of the laser beam propagating to the bonding head through an optical fiber using a focusing lens installed on the bonding head.

20. The method of claim 17, further comprising pressing the contact portions using a pressing tool, which is disposed between the contact portions and the bonding head to press the contact portions and is made of a transparent material such that the laser beam applied from the bonding head is transmitted.

21. The method of claim 17, wherein:
the camera unit further comprises a hard printed circuit board (HPCB) having a plurality of first bonding pads such that the image sensor is bonded to one surface thereof and the FPCB is bonded to the other surface thereof;
the FPCB comprises a plurality of second bonding pads on one surface thereof to be bonded to the first bonding pads; and
the bonding comprises applying the laser beam to contact portions of the bonding pads from a side of the other surface of the FPCB when the first bonding pads and the second bonding pads come into contact with each other.

22. The method of claim 21, wherein:
the first bonding pads and the second bonding pads are formed at edges of the HPCB and the FPCB, respectively; and
the bonding comprises applying the laser beam to the edges at which the bonding pads are formed using the bonding head.

23. The method claim 21, wherein the bonding comprises applying the laser beam having a predetermined width to the contact portions of the bonding pads using the bonding head, the width of the applied laser beam being equal or similar to that of either each second bonding pad or the FPCB.

24. The method of claim 21, wherein the bonding comprises applying the laser beam having a predetermined area to the contact portions of the bonding pads using the bonding head, the area of the applied laser beam being equal or similar to that of the other surface of the HPCB.
